(19) United States
(12) Patent Application Publication
(10) Pub. No.: US 2020/0230831 A1
(43) Pub. Date: Jul. 23, 2020

(54) FOLDING KNIFE

(71) Applicant: Cold Steel, Inc., Venture, CA (US)

(72) Inventors: Andrew Demko, Wampum, PA (US); Mike Wallace, New Castle, PA (US)

(73) Assignee: Cold Steel, Inc., Ventura, CA (US)

(21) Appl. No.: 16/252,522

(22) Filed: Jan. 18, 2019

(51) Int. Cl. B26B 1/04

(52) U.S. Cl. CPC B26B 1/044

(57) ABSTRACT

A folding knife has an elongated blade having a pivot end and an opposed free end, the pivot end of the blade pivotally connected to a handle, the blade being movable between a closed position in which the blade is protectively received by the handle and an open position in which the blade extends away from the handle, a liner lock element connected to the handle and having a block portion, the liner lock element movable between a locked position in which the block portion operably contacts a portion of the pivot end of the blade to prevent movement of the blade from the open position to the closed position, and an unlocked position in which movement of the blade from the open position to the closed position is enabled, and a safety element movable between an engaged position and a disengaged position.

### FIELD OF THE INVENTION

The present invention relates to knives, and more particularly to a folding knife that features a liner lock with a secondary safety that when engaged makes the liner lock enormously resistant to shock and impact.

### BACKGROUND OF THE INVENTION

Liner lock knives are a popular style of folding pocket knives. “Liner lock” refers to a blade locking mechanism, which is a side-spring detent lock that can be opened and closed with one hand without repositioning the knife. The liner lock's lock bar abuts the tang of the blade in the open position to prevent the blade from closing. To release the lock, the user presses the lock bar back toward the handle side, which shifts the lock bar out of the way, enabling the blade to close. In the closed position, the lock bar rests alongside the handle and the blade, typically employing a ball detent to releasably secure the blade in the closed position. A serious disadvantage of liner lock folding knives is that inadvertent movement of the liner, or extreme force exerted upon the blade, can cause the blocking portion of the liner to be dislodged from the notch on the blade's tang, enabling the blade to close unintentionally. Inadvertent closure of the blade could lead to serious injury to the user.

Therefore, a need exists for a new and improved folding knife that features a liner lock with a secondary safety that when engaged makes the liner lock enormously resistant to shock and impact. In this regard, the various embodiments of the present invention substantially fulfill at least some of these needs. In this respect, the folding knife according to the present invention substantially departs from the conventional concepts and designs of the prior art, and in doing so provides an apparatus primarily developed for the purpose of featuring a liner lock with a secondary safety that when engaged makes the liner lock enormously resistant to shock and impact.

### SUMMARY OF THE INVENTION

The present invention provides an improved folding knife, and overcomes the above-mentioned disadvantages and drawbacks of the prior art. As such, the general purpose of the present invention, which will be described subsequently in greater detail, is to provide an improved folding knife that has all the advantages of the prior art mentioned above.

To attain this, the preferred embodiment of the present invention essentially comprises an elongated blade having a pivot end and an opposed free end, the pivot end of the blade pivotally connected to a handle, the blade being movable between a closed position in which the blade is protectively received by the handle and an open position in which the blade extends away from the handle, a liner lock element connected to the handle and having a block portion, the liner lock element movable between a locked position in which the block portion operably contacts a portion of the pivot end of the blade to prevent movement of the blade from the open position to the closed position, and an unlocked position in which movement of the blade from the open position to the closed position is enabled, a safety element movable between an engaged position and a disengaged position, when the blade is in the open position the safety element being configured when in the engaged position to contact the liner lock element and to prevent the liner lock element from moving to the unlocked position, and when the safety element is in the disengaged position movement of the liner lock element to the unlocked position is enabled to enable movement of the blade to the closed position. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is an exploded view of the current embodiment of the folding knife constructed in accordance with the principles of the present invention.

FIG. 2 is a left side view of the current embodiment of the right liner of the folding knife of FIG. 1 with the left liner removed with the blade unfolded, the liner lock locked, and the safety disengaged.

FIG. 3 is a bottom fragmentary view of the current embodiment of the right liner of the folding knife of FIG. 1 with the left liner removed with the blade unfolded, the liner lock locked, and the safety disengaged.

FIG. 4 is a left side view of the current embodiment of the right liner of the folding knife of FIG. 1 with the right liner removed with the blade unfolded, the liner lock locked, and the safety engaged.

FIG. 5 is a bottom fragmentary view of the current embodiment of the right liner of the folding knife of FIG. 1 with the left liner removed with the blade unfolded, the liner lock locked, and the safety engaged.

The same reference numerals refer to the same parts throughout the various figures.

### DESCRIPTION OF THE CURRENT EMBODIMENT

An embodiment of the folding knife of the present invention is shown and generally designated by the reference numeral 10.

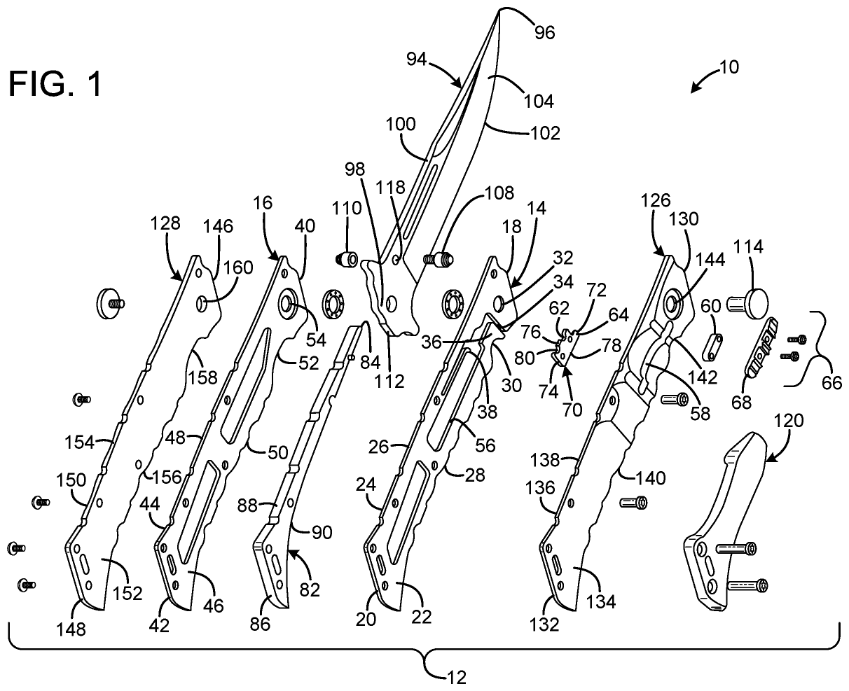

FIGS. 1-5 illustrate the improved folding knife 10 of the current invention. More particularly, the folding knife has an elongated handle 12 having a right liner 14 and a left liner 16. The right liner is a planar body having a front 18, rear 20, exterior 22, interior 24, top 26, bottom 28, and a peripheral profile. The exterior and interior are opposed major faces. The bottom front of the right liner defines a finger recess 30 that accommodates the user's index finger when the knife is held in the fully opened position. The front of the right liner defines a pivot aperture 32. The top middle of the right liner defines a slot 34. A portion of the right liner just in front of the finger recess that defines a rear portion of the slot is a block portion/lock bar 36. Thus, the right liner can be viewed as a liner lock element. The lock bar is a leaf spring that is biased to the locked position (inwardly toward the blade 94). A portion of the right liner above and just rearward of the finger recess is a spring detent 38 formed by an elongated cantilever element. Thus, the lock bar and spring detent are formed of a common unitary piece of material.

The left liner 16 has a front 40, rear 42, exterior 44, interior 46, top 48, and bottom 50. The bottom front of the left liner defines a finger recess 52 that accommodates the user's index finger when the knife is held in the fully opened position. The front of the left liner defines a pivot aperture 54.

The elongated handle 12 also includes a right scale 126 and a left scale 128. The right scale has a front 130, rear 132, exterior 134, interior 136, top 138, and bottom 140. The bottom front of the right scale defines a finger recess 142 that accommodates the user's index finger when the knife is held in the fully opened position. The front of the right liner defines a pivot aperture 144. The interior of the right scale abuts the exterior 22 of the right liner 14 when the folding knife 10 is assembled.

The left scale 128 has a front 146, rear 148, exterior 150, interior 152, top 154, and bottom 156. The bottom front of the left scale defines a finger recess 158 that accommodates the user's index finger when the knife is held in the fully opened position. The front of the left liner defines a pivot aperture 160. The interior of the left scale abuts the exterior 44 of the left liner 16 when the folding knife 10 is assembled.

The middle of the right liner 14 defines a slot 56 that is in communication with the lock bar 36 and spring detent 38. The right scale defines a safety slider slot 58 just behind the pivot aperture 144. A safety element 66 has a safety slider 68 connected to a safety limiter 60 slidably received within the safety slider slot and a safety plate 70 slidably received in the slot in the right liner and connected to the safety limiter. The safety limiter can be moved forward and rearward within the confines of the safety slider slot, which determines the range of motion of the safety element. The safety slider is an actuator surface external to the handle 12. The handle is an elongated body defining a major axis 124, and the safety element is movable along the major axis. The safety slider slot is a safety aperture in the handle that enables a portion of the safety element (the safety slider) to extend through the safety aperture and a portion of the safety element (the safety plate) located inside the handle. The safety plate has a front 72, rear 74, top 76, and bottom 78. The top of the safety plate defines a forward limit notch 62 and a rear limit notch 80. The bottom front of the safety plate includes a nose 64.

A handle spine 82 is received between the top 26 of the right liner 14 and the top 48 of the left liner 16. The handle spine has a front 84, rear 86, top 88, and bottom 90. The bottom 90 of the handle spine is curved to protectively receive the blade 94 when the blade is in the folded/closed position.

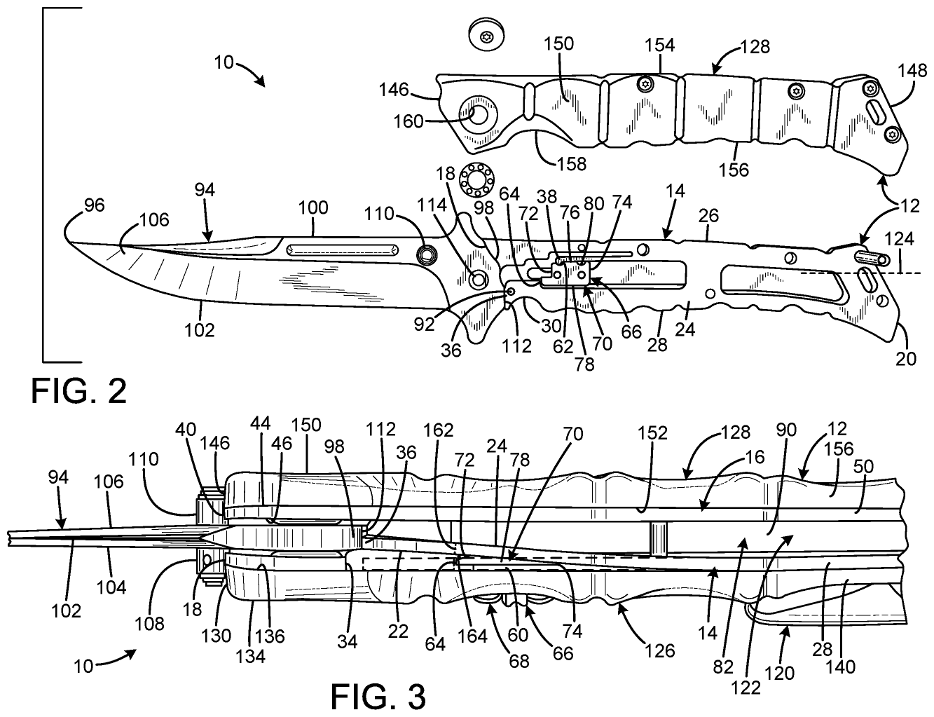

The elongated blade 94 is a planar body pivotally mounted on a blade pivot pin 114 received in the pivot apertures 32, 54 in the right and left liners 14, 16. The blade has a tip end/opposed free end 96, a tang/pivot end 98, a spine edge 100, a cutting-edge 102, a right face 104, and an opposed left face 106. Thumb studs 108, 110 protrude outwardly from the right face and left face just below the spine edge to facilitate blade opening. A rear portion of the tang defines a lock portion 112 that is sized to abut the lock bar 36 when the blade is in the open/unfolded position. When the lock bar abuts the lock portion in the rear portion of the tang, the blade is locked in the unfolded/open position and cannot be closed. The right face of the tang also includes a recess 118 that receives a ball detent 92 located on the lock bar (shown in FIGS. 2 & 4) when the blade is folded/closed, which causes the blade to provide some resistance to opening when the safety element is disengaged.

A clip 120 is attached to the rear 132 of the right scale 126. The clip enables the folding knife 10 to be releasably secured to a belt, the edge of a pocket, or any other suitable item.

FIGS. 2 & 3 illustrate the improved folding knife 10 of the current invention with the blade 94 locked in the unfolded/open position by the lock bar 36 with the safety element 66 disengaged. The blade extends away from the handle 12 in the open position. More particularly, the safety element has been slid rearward within the safety slider slot 58 and the slot 56 in the right liner 14 to the disengaged position. In the disengaged position, the forward limit notch 62 is positioned beneath the spring detent 38, which releasably secures/resists movement of the safety plate 70 and the connected portions of the safety element in the disengaged position. In the disengaged position, the nose 64 of the safety plate is not engaged with the lock bar (the nose does not extend beyond dashed line 162 on the right liner 14). Thus, the safety element is clear of the lock bar's peripheral profile when in the disengaged position. With the nose of the safety element clear of the lock bar, the lock bar is free to be depressed once sufficient inward force is exerted to overcome the spring pressure of the lock bar. Thus, although the lock bar continues to lock the blade in the unfolded/open position, the user can depress the lock bar outwardly to enable the blade to fold. Thus, when the blade is in the open position, the safety element is configured when in the engaged position to contact the lock bar to prevent the lock bar from moving to the unlocked position, and when the safety element is in the disengaged position, movement of the lock bar to the unlocked position is enabled to enable movement of the blade to the closed position. The lock bar is moved to the unlocked position by application of outward pressure to a portion of the lock bar exposed by the finger recesses 30, 142 in the right liner 14 and right scale 126, such that the lock bar moves away from the pivot portion/tang 98 of the blade when the lock bar is moved to the unlocked position.

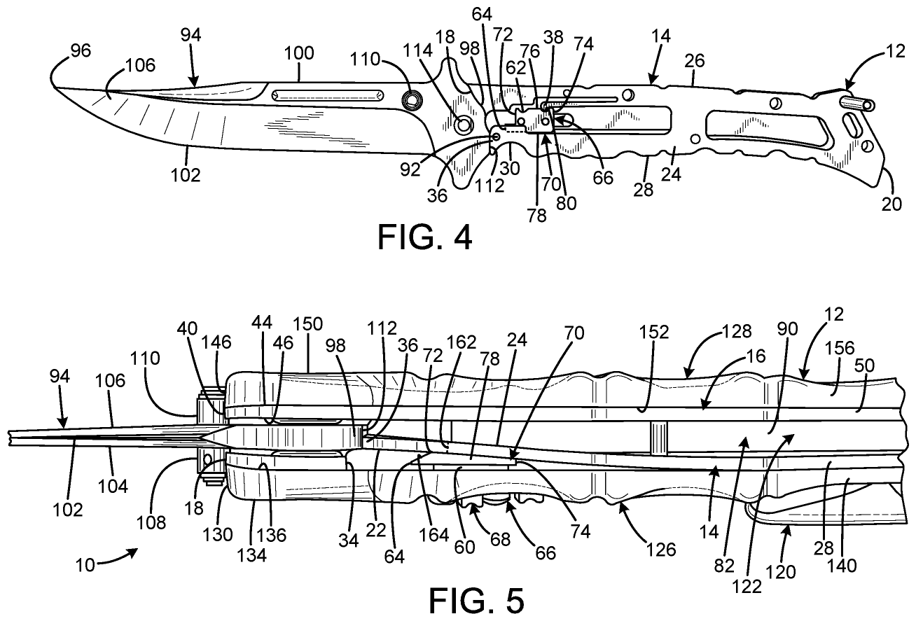

FIGS. 4 & 5 illustrate the improved folding knife 10 of the current invention with the blade 94 locked in the unfolded/open position by the liner lock 86 with the safety element 66 engaged. The blade extends away from the handle 12 in the open position. More particularly, the safety element has been slid forward within the safety slider slot 58 and the slot 56 in the right liner 14 to the engaged position. In the engaged position, the rear limit notch 80 is positioned beneath the spring detent 38, which releasably secures/resists movement of the safety plate 70 and the connected portions of the safety element in the engaged position. In the engaged position, the nose 64 of the safety plate is engaged with the lock bar (the nose extends beyond dashed line 162 on the right liner 14). Thus, the safety element overlaps the peripheral profile of the lock bar when in the engaged position. The nose of the safety plate can be viewed as a safety engaging surface configured to contact the lock bar when the safety element is in the engaged position and the lock bar is in the locked position to prevent movement of the lock bar to the unlocked position. With the nose of the safety plate positioned beneath the lock bar, the lock bar is obstructed from being depressed outwardly. As a result, the lock bar cannot deflect to disengage the lock bar from the lock portion of the tang of the blade. Thus, the engaged safety element makes the lock bar enormously resistant to shock and impact, which prevents inadvertent folding/closure of the blade. In the current embodiment, the nose of the safety plate has a sloped portion 164 to facilitate insertion of the nose of the safety plate between the lock bar and the right scale 126 to hold the lock bar inward to prevent blade closure.

When the safety element 66 is in the disengaged position, sufficient outward force can be exerted upon the lock bar 36 to overcome the inward spring force of the lock bar and deflect the lock bar out of engagement with the lock portion 112 in the tang 98 of the blade to the position denoted by dashed lines in FIG. 3. In this unlocked position, the right liner 14 is a unitary piece of material that is a flat planar body having opposed parallel surfaces. Once the lock bar is in the unlocked position, the user can press downward on the spine edge 100 of the blade to pivot the blade clockwise about the blade pivot pin 114 to begin folding/closing the blade. The lock bar rides on the right face 104 of the tang to enable further pivoting of the blade until the blade reaches the folded/closed position. The lock bar is positioned against one of the blade's opposed major faces (the right face) when the blade is in the folded/closed position with the ball dent 92 received in the recess 118 on the right face of the tang. Thus, the lock bar is movable between a locked position in which the lock bar/block portion operably contacts a portion of the pivot end of the blade (lock portion 112 in the tang of the blade) to prevent movement of the blade from the open position to the closed position, and an unlocked position in which movement of the blade from the open position to the closed position is enabled. While the ball detent on the lock bar of the liner lock engages the recess on the right face of the tang, the blade will not open unless sufficient force is applied to one of the thumb studs 108, 110 to dislodge the ball detent from the recess. In the folded/closed position, the blade is protectively received in a channel 122 defined by the interiors 24, 46 of the right and left liners 14, 16 of the handle 12 and the bottom 90 of the handle spine 82.

While a current embodiment of a folding knife has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A folding knife comprising: an elongated blade having a pivot end and an opposed free end; the pivot end of the blade pivotally connected to a handle; the handle having a pair of scales, one of the scales defining a safety aperture therethrough; the blade being movable between a closed position in which the blade is protectively received by the handle and an open position in which the blade extends away from the handle; a liner lock element connected to the handle and having a lock bar with a block portion; the lock bar movable between a locked position in which the block portion operably contacts a portion of the pivot end of the blade to resist movement of the blade from the open position to the closed position, and an unlocked position in which movement of the blade from the open position to the closed position is enabled, the lock bar being biased towards the locked position; a safety element having a slider, the slider having an actuator surface external to the handle, the slider being connected to the safety element through the safety aperture, the safety element being movable between an engaged position and a disengaged position; when the blade is in the open position the safety element being configured when in the engaged position to contact the lock bar and to resist the lock bar from moving to the unlocked position, and when the safety element is in the disengaged position, movement of the lock bar to the unlocked position is enabled to enable movement of the blade to the closed position; the folding knife including a spring decent engaging the safety element to resist movement of the safety element from at least one of the engaged and disengaged positions.

2. The folding knife of claim 1 wherein the handle is an elongated body defining a major axis, and wherein the safety element is movable along the major axis.

3. The folding knife of claim 1 wherein the blade is a planar body having opposed major faces and wherein the block portion of the lock bar is positioned against one of the major faces when the blade is in a closed position.

4. (canceled)

5. The folding knife of claim 1 wherein the lock bar is a planar body having opposed major faces and a peripheral profile, and wherein the safety element is clear of the peripheral profile when in the disengaged position and overlapping the peripheral profile when in the engaged position.

6-8. (canceled)

9. The folding knife of claim 1 wherein the spring detent includes an elongated cantilever element.

10. The folding knife of claim 1 wherein the spring detent and the liner lock element are formed of a common unitary piece of material,

11. The folding knife of claim 10 wherein the unitary piece of material is a flat planar body having opposed parallel surfaces when the liner lock element is in the unlocked position.
